(19) United States
(12) Patent Application Publication
(10) Pub. No.: US 2021/0408898 A1
(43) Pub. Date: Dec. 30, 2021

(54) POWER REGENERATION SNUBBER CIRCUIT AND POWER SUPPLY DEVICE

(71) Applicant: SHARP KABUSHIKI KAISHA, Osaka (JP)

(72) Inventor: TAKESHI SHIOMI, Osaka (JP)

(73) Assignee: SHARP KABUSHIKI KAISHA, Osaka (JP)

(21) Appl. No.: 17/334,344

(22) Filed: May 28, 2021

(30) Foreign Application Priority Data
Jun. 29, 2020 (JP) 2020-111849

(51) Int. Cl. H02M 1/34; H02M 7/217

(52) U.S. Cl. CPC H02M 1/348; H02M 7/217

(57) ABSTRACT

A snubber circuit connected to a rectifying circuit including a reference potential node, an output potential node, and a first switch node, the snubber circuit comprises a snubber capacitor; a first snubber diode; a snubber coil; and a snubber resistor, wherein a negative electrode of the snubber capacitor is connected to the reference potential node, an anode of the first snubber diode is connected to the first switch node and a cathode of the first snubber diode is connected to a positive electrode of the snubber capacitor, and one end of a series circuit configured by the snubber coil and the snubber resistor is connected to the positive electrode of the snubber capacitor, and another end of the series circuit is connected to the output potential node.

### CROSS-REFERENCE TO RELATED APPLICATION

The present application claims priority front Japanese Application JP2020-111849, the content of which is hereby incorporated by reference into this application.

### BACKGROUND

### 1. Field

The following disclosure relates to a snubber circuit.

The snubber circuit is added to suppress a surge voltage applied to a switch element. On the other hand, losses that occur in the snubber circuit are also problematic. JP 2009-247132 A discloses a circuit for reducing losses in a snubber circuit.

### SUMMARY

However, even with such a snubber circuit, there is still room for loss reduction. One aspect of the present disclosure has an object to provide a snubber circuit capable of reducing losses as compared to the related art.

In order to solve the above problem, a snubber circuit according to one aspect of the present disclosure is a snubber circuit connected to a rectifying circuit including a reference potential node, an output potential node, and a first switch node, a voltage of the output potential node being set higher than a voltage of the reference potential node, a maximum voltage of the first switch node being set higher than the voltage of the output potential node, the snubber circuit including a snubber capacitor, a first snubber diode, a snubber coil, and a snubber resistor, wherein a negative electrode of the snubber capacitor is connected to the reference potential node, an anode of the first, snubber diode is connected to the first switch node and a cathode of the first snubber diode is connected to a positive electrode of the snubber capacitor, and one end of a series circuit, configured by the snubber coil and the snubber resistor is connected to the positive electrode of the snubber capacitor, and another end of the series circuit is connected to the output potential node.

According to one aspect of the present disclosure, it is possible to reduce the losses in the snubber circuit.

### BRIEF DESCRIPTION OF DRAWINGS

FIG. 1 is a diagram illustrating a snubber circuit and a rectifying circuit according to a first embodiment.

FIG. 2 is a diagram illustrating current paths of the snubber circuit.

FIG. 3 is a diagram illustrating operation waveforms of the snubber circuit.

FIG. 4 is a diagram illustrating an application example of a snubber circuit 1 according to a second embodiment.

FIG. 5 is a diagram illustrating a power supply device according to a third embodiment.

### DESCRIPTION OF EMBODIMENTS

### First Embodiment

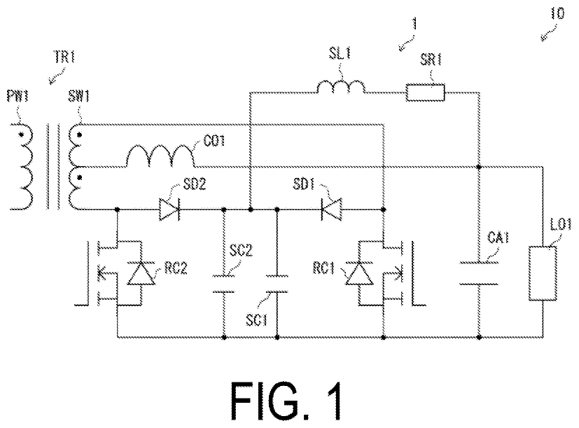

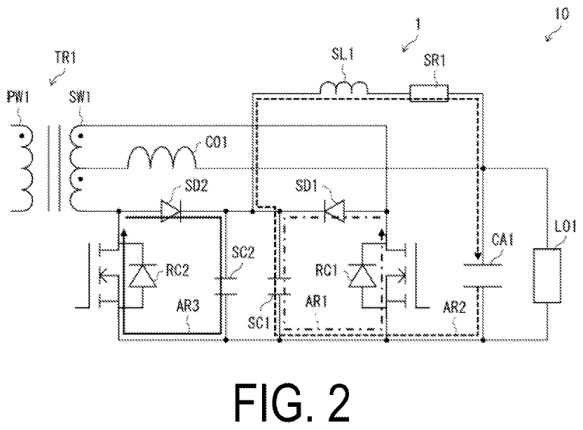

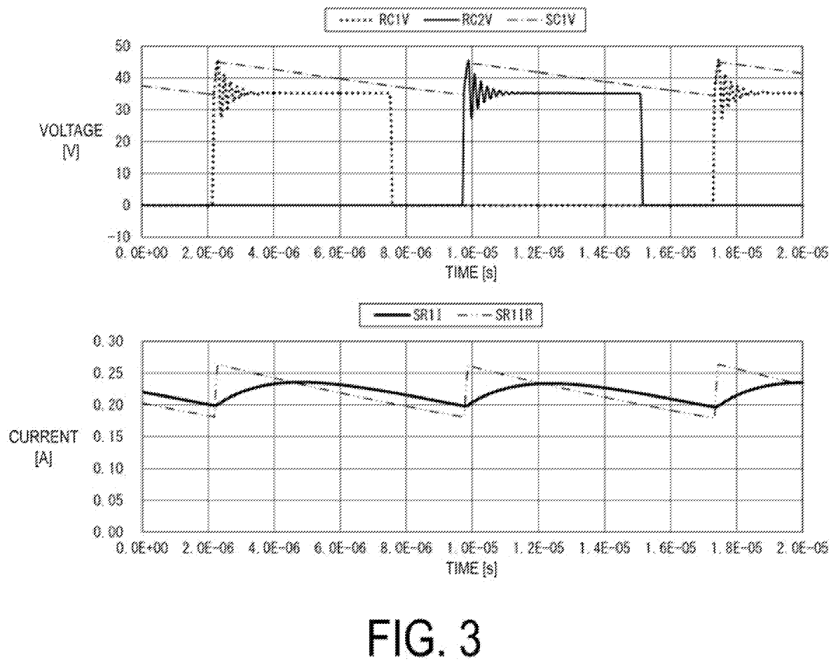

A snubber circuit 1 according to a first embodiment suppresses a surge voltage generated in a rectifying circuit 10 as well as suppresses losses generated in the snubber circuit 1. A circuit configuration of the rectifying circuit 10 and the snubber circuit 1 will be described using FIG. 1. Current paths of the snubber circuit 1 will be described using FIG. 2. Operation waveforms of the snubber circuit 1 will be described using FIG. 3. For the sake of brevity, “transformer TR1” is also simply referred to as “TR1”, for example. Note that each numerical value described below is merely an example.

### Overview of Rectifying Circuit 10

The rectifying circuit 10 is a secondary side rectifying circuit of an insulating DC-DC converter 100 (described below). The rectifying circuit 10 includes a reference potential node, an output potential node, and a first switch node. The rectifying circuit 10 converts an AC electromotive force of the transformer TR1 induced by a primary side circuit of the insulating DC-DC converter 100 to a DC voltage. This circuit is referred to as a center tap rectifying circuit, and performs full-wave rectification.

### Configuration of Rectifying Circuit 10

The transformer TR1 includes a primary winding PW1 and a secondary winding SW1. PW1 is connected to the primary side circuit, and SW1 is connected to the secondary side circuit. SW1 is a two-turn winding, and one end of a smoothing coil CO1 is connected to a midpoint (center tap) of SW1. A positive electrode of the smoothing capacitor CA1 is connected to the other end of CO1. A negative electrode of CA1 is connected to a reference potential node. A load LO1 is connected in parallel to CA1. One end of SW1 is connected to the reference potential node via a rectifying element RC1. A connection point between the one end of SW1 and RC1 is a first switch node. The other end of SW1 is connected to the reference potential node via a rectifying element RC2. A connection point between the other end of SW1 and RC2 is a second switch node.

A voltage of the reference potential node is 0 V. The positive electrode of CA1 is an output potential node and has a voltage of 12.5 V. The first and second switch nodes switch between approximately 0 V (during conduction) and approximately 35 V (during non-conduction) in voltage. This 35 V voltage is the maximum voltage of each switch node. The definition of “the maximum voltage of each switch node” does not include instantaneous voltages such as surge voltages and noises. The magnitude of the voltage of each node is set to “the reference potential node<the output potential node<the maximum voltage of each switch node”.

CO1 has an inductance of 1.8 μH and a DC resistance of 0.3 mΩ. An average current is 80 A. CA1 has a capacitance of 8.8 mF. RC1 and RC2 are metal oxide semiconductor field effect transistors (MOSFETs) each having a drain breakdown voltage of 80 V. The MOSFETs are connected in parallel such that each of on resistances of RC1 and RC2 is 0.4 mΩ.

### AC Operation and Surge Voltage of Rectifying Circuit 10

The voltages of the first and second switch nodes connected to SW1 are switched by an AC electromotive force having a frequency of 66 kHz. The voltage of the first switch node is 35 V during the positive half-cycle and the voltage of the second switch node is 35 V during the negative half-cycle. The surge voltage is generated when switching to this 35 V, and instantaneously becomes 60 V. The surge voltages generated in the positive and negative cycles within one cycle are shifted in phase by 180 degrees between the first and second switch nodes with a frequency of 132 kHz, which is twice 66 kHz.

### Configuration of Snubber Circuit 1

The snubber circuit 1 connected to the rectifying circuit 10 includes snubber capacitors SC1 and SC2, a first snubber diode SD1 and a second snubber diode SD2, a snubber coil SL1, and a snubber resistor SR1.

A negative electrode of SC1 is connected to the reference potential node. An anode of SD1 is connected to the switch node, and a cathode of SD1 is connected to a positive electrode of SC1. SL1 and SR1 are connected in series, and one end thereof is connected to the positive electrode of SC1 and the other end thereof is connected to the output potential node. The order of connection between SL1 and SR1 can be changed as appropriate. A negative electrode of SC2 is connected to the reference potential node. An anode of SD2 is connected to the second switch node, and a cathode of SD2 is connected to a positive electrode of SC2. One end of a series circuit of SL1 and SR1 is connected to the positive electrode of SC2, as well as being connected to the positive electrode of SC1. In other words, SC1 and SC2 are in parallel, and any one of the snubber capacitors can be reduced.

SC1 and SC2 have a capacitance of 80 nF. SD1 and SD2 have a VF of 0.75 V at a point; in time of the start of conduction and a resistance of 0.06Ω during conduction. SL1 has an inductance of 220 μH and a DC resistance of 3Ω. SR1 has a resistance of 120Ω.

### Operation of Snubber Circuit 1

Regenerative operation of a surge power generated at the first switch node will be described. The surge voltage generated at the first switch node charges SC1 using a path AR1 via SD1, SC1, and RC1. Charged SC1 charges CA1 through a path AR2 via SL1, SR1, and CA1. Thus, the surge power can be supplied to an output side of the rectifying circuit 10. The surge power generated at the second switch node can also be similarly regenerated. The charging path of SC2 is AR3, but the charging path of CA1 is AR2, which is the same as that of the first switch node.

In the rectifying circuit 10 to which the snubber circuit 1 is connected, the average voltage of SC1 is designed to be approximately the same level (±40%) as the maximum voltage of the switch node. In the present embodiment, it is designed to be approximately 40 V. In connection between SC1 (40 V) and CA1 (12.5 V), a problem is generated in which the voltage difference generates over current and the voltage of SC1 is greatly reduced. Thus, in a circuit where the maximum voltage of the switch node is higher than the voltage of the output potential node, SR1 is required to be connected in order to suppress the over current.

SL1 is connected in order to smooth the surge power cyclically generated.

### Operation Waveforms of Snubber Circuit 1

Operation waveforms of the power regeneration by the snubber circuit 1 will be described using FIG. 3. The upper graph of FIG. 3 is a graph in which the vertical axis represents voltage. The lower graph illustrates a graph in which the vertical axis represents current. The horizontal axes of the graphs use the same time axis. Each item of the graphs is as follows.

RC1V: Voltage of the first switch node

RC2V: Voltage of the second switch node

SC1V: Voltage of SC1

SR1I: Current of SR1

SR1IR: Current of SR1 when SL1 is not used (only SR1)

In one cycle of 66 kHz (period of 1.5 E-6 s), the surge voltages of. RC1V and RC2V can be confirmed. Thus, it can be confirmed that SC1V is repeatedly increasing in voltage at a frequency of 132 kHz (twice as high as 66 kHz).

In the present embodiment, the resistance is set as small as possible in order to efficiently regenerate the power absorbed in SC1. This causes the discharge of SC1V to be fast, and SC1V ripples by approximately 10 V. As a comparative example, when SL1 is not used (only SR1), a ripple of 0.08 A is generated in SR1IR, which causes losses, when using SL1 of the present embodiment, the ripple current of SR1I is suppressed down to 0.04 A, which improves the regenerative efficiency. In addition, the surge voltage suppression effect of the snubber circuit 1 can also be confirmed. The instantaneous peak of the snubber circuit 1 can be reduced to 45 V whereas the instantaneous peak of the voltages of the first and the second switch nodes is 60 V when the snubber circuit 1 is not connected.

### Improvements 1 to 3 of Snubber Circuit 1

In the first embodiment, a plurality of preferred improvements are applied. These preferred improvements will be described below.

Improvement 1: Impedance of the Snubber Coil is Higher than Impedance of the Snubber Resistor.

Since the series impedance of SL1+SR1 is a complex number, by setting the impedance to SL1≥SR1, the impedance of SL1 is allowed to act dominantly. More preferably, in a case of twice or more, the impedance can be more effectively increased. In a case of 10 times or more, an increase in size of SL1 with respect to a reduced amount of the ripple current is a problem. In this embodiment, since the frequency is 132 kHz and the inductance is 220 μH, SL1 is 182Ω and effectively reduces the ripple current.

Improvement 2: The Rectifying Circuit Includes the Second Switch Node and the Second Snubber Diode.

The rectifying circuit of the present embodiment includes the first switch node and the second switch node. The surge powers of the two switch nodes charge SC1 via SD1 and SD2. Since 132 kHz, which is a frequency twice as high, is applied to SL1, the ripple current can be effectively reduced.

Improvement 3: Switching of the First and the Second Switch Nodes is Shifted in Phase by 180 Degrees.

Since the rectifying circuit according to the present embodiment performs AC rectification as described above, the surge timing of the second switch node relative to the surge timing of the first switch node is shifted in phase by 180 degrees. The surge powers are evenly distributed, so that the ripple current of SL1 can be effectively suppressed. In order to achieve this effect, the shift in phase preferably ranges from 150 degrees to 210 degrees.

### Second Embodiment

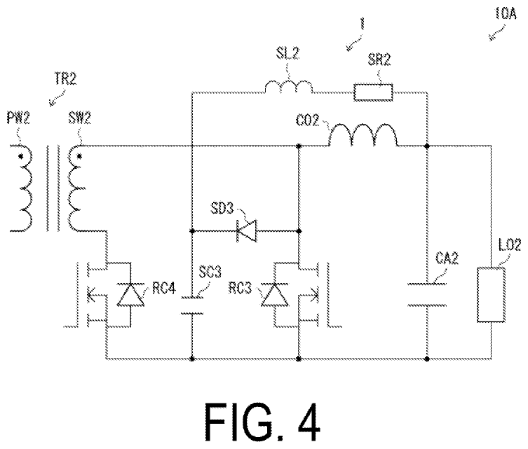

The snubber circuit 1 is applicable to any rectifying circuit including the reference potential node, the output potential node, and the first switch node. The present embodiment illustrates an application example of the snubber circuit 1 to a half-wave rectifying circuit 10A illustrated in FIG. 4.

A transformer TR2 includes a primary winding PW2 and a secondary winding SW2. RC3 and RC4 are included as rectifying elements. A smoothing coil CO2 and a smoothing capacitor CA2 are included. The snubber circuit 1 includes a snubber diode SD3, a snubber capacitor SC3, a snubber coil SL2, and a snubber resistor SR2. The first switch node is a connection point between SW2 and RC3. The voltage of the reference potential node is 0 V, the voltage of the output potential node is 12.5 V, and the maximum voltage of the switch node is 50 V. The snubber circuit 1 can also be applied to such a circuit.

Other application examples include a current doubler rectifying circuit or a full-bridge rectifying circuit. Similar to the first embodiment, these are rectifying circuits including the reference potential node, the output potential node, and the first and second switch nodes, and thus the snubber circuit 1 can be applicable.

### Third Embodiment

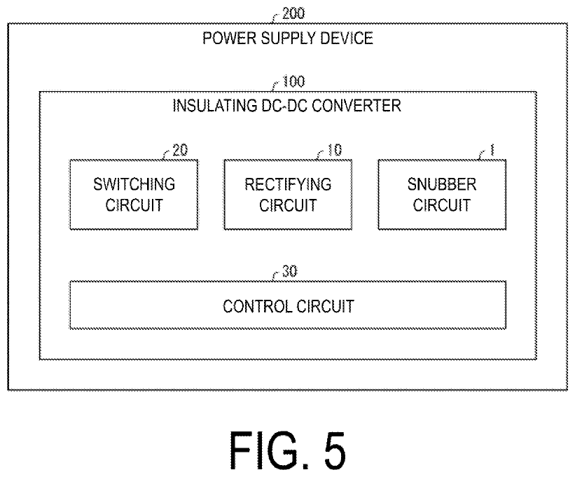

FIG. 5 is a diagram illustrating a power supply device 200 including the snubber circuit 1. The power supply device 200 includes an insulating DC-DC converter 100. The insulating DC-DC converter 100 includes a switching circuit 20 as a primary side circuit, a rectifying circuit 10 as a secondary side circuit, the snubber circuit 1, and a control circuit 30. The switching circuit 20 and the rectifying circuit 10 are connected via a transformer. The snubber circuit 1 is directly connected to the rectifying circuit 10. The control circuit 30 is connected so that the on/off of each element provided in the insulating DC-DC converter 100 can be controlled.

### Supplement

A snubber circuit according to a first aspect of the present disclosure is a snubber circuit connected to a rectifying circuit including a reference potential node, an output potential node, and a first switch node, a voltage of the output potential node being set higher than a voltage of the reference potential node, a maximum voltage of the first switch node being set higher than the voltage of the output potential node, the snubber circuit including a snubber capacitor, a first snubber diode, a snubber coil, and a snubber resistor, wherein a negative electrode of the snubber capacitor is connected to the reference potential node, an anode of the first snubber diode is connected to the first switch node and a cathode of the first snubber diode is connected to a positive electrode of the snubber capacitor, and one end of a series circuit configured by the snubber coil and the snubber resistor is connected to the positive electrode of the snubber capacitor, and another end of the series circuit is connected to the output potential node.

According to the above-described configuration, the first snubber diode enables the surge power generated at the first switch node to be charged to the snubber capacitor and prevents current from flowing back from the snubber capacitor to the first switch node. The surge cower charged to the snubber capacitor is regenerated to the output potential node using the snubber resistor and the snubber coil. The snubber resistor can suppress the over current from the first switch node to the output potential node. The snubber coil can suppress the ripple current, so that low-loss power regeneration is enabled.

In a snubber circuit according to a second aspect of the present disclosure, the impedance of the snubber coil is twice or more of the impedance of the snubber resistor.

According to the above-described configuration, the ripple current can be effectively suppressed using the inductance of the snubber coil.

In a snubber circuit according to a third aspect of the present disclosure, the rectifying circuit further including a second switch node, and the snubber circuit further including a second snubber diode, wherein a maximum voltage of the second switch node is set higher than the voltage of the output potential node, an anode of the second snubber diode is connected to the second switch node, and a cathode of the second snubber diode is connected to the positive electrode of the snubber capacitor.

According to the above-described configuration, the frequency of the surge voltage charged to the snubber capacitor is twice. According to an increase in frequency, the impedance of the snubber coil is twice, so that the ripple current can be effectively suppressed.

In a snubber circuit according to a fourth aspect of the present disclosure, switching of the first switch node and switching of the second switch node are shifted in phase by approximately 180 degrees.

According to the above-described configuration, by being shifted in phase by 180 degrees, the surge power is evenly distributed, and the ripple current can be effectively suppressed.

A power supply device according to a fifth aspect of the present disclosure includes the snubber circuit according to one aspect of the present disclosure.

According to the above-described configuration, the power supply device with reduced losses can be realized using the snubber circuit with reduced losses.

### Supplementary Information

An aspect of the present disclosure is not limited to each of the embodiments described above. It is possible to make various modifications within the scope indicated in the claims. An embodiment obtained by appropriately combining technical elements each disclosed in different embodiments falls also within the technical scope of an aspect of the present disclosure. Furthermore, technical elements disclosed in the respective embodiments may be combined to provide a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A snubber circuit connected to a rectifying circuit including a reference potential node, an output potential node, and a first switch node, a voltage of the output potential node being set higher than a voltage of the reference potential node, a maximum voltage of the first switch node being set higher than the voltage of the output potential node, the snubber circuit comprising:
a snubber capacitor;
a first snubber diode;
a snubber coil; and
a snubber resistor,
wherein a negative electrode of the snubber capacitor is connected to the reference potential node, an anode of the first snubber diode is connected to the first switch node and a cathode of the first snubber diode is connected to a positive electrode of the snubber capacitor, and
one end of a series circuit configured by the snubber coil and the snubber resistor is connected to the positive electrode of the snubber capacitor, and another end of the series circuit is connected to the output potential node.

2. The snubber circuit according to claim 1,
wherein impedance of the snubber coil is twice or more of impedance of the snubber resistor.

3. The snubber circuit according to claim 1,
wherein the rectifying circuit further includes a second switch node,
the snubber circuit further comprising a second snubber diode,
a maximum voltage of the second switch node is set higher than the voltage of the output potential node, and
an anode of the second snubber diode is connected to the second switch node, and a cathode of the second snubber diode is connected to the positive electrode of the snubber capacitor.

4. The snubber circuit according to claim 2,
wherein the rectifying circuit further includes a second switch node,
the snubber circuit further comprising a second snubber diode,
a maximum voltage of the second switch node is set higher than the voltage of the output potential node, and
an anode of the second snubber diode is connected to the second switch node, and a cathode of the second snubber diode is connected to the positive electrode of the snubber capacitor.

5. The snubber circuit according to claim 3,
wherein switching of the first switch node and switching of the second switch node are shifted in phase by approximately 180 degrees.

6. The snubber circuit according to claim 4,
wherein switching of the first switch node and switching of the second switch node are shifted in phase by approximately 180 degrees.

7. A power supply device comprising
the snubber circuit according to claim 1.
